(19) United States
(12) Patent Application Publication
(10) Pub. No.: US 2007/0230561 A1
(43) Pub. Date: Oct. 4, 2007

(54) IMAGE SUPPLY DEVICE, IMAGE DISPLAY DEVICE, IMAGE TRANSFER SYSTEM, AND METHOD OF DETERMINING IMAGE COMPRESSION METHOD

(75) Inventor: Hiroyuki ICHIEDA, Matsumoto-shi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 11/674,400

(22) Filed: Feb. 13, 2007

(30) Foreign Application Priority Data
Mar. 28, 2006 (JP) 2006-087349

(51) Int. Cl. H04B 1/66

(52) U.S. Cl. 375/240

(57) ABSTRACT

An image supply device to be connected to an image display device via a predetermined transmission channel, for supplying the image display device with an image signal by transferring the image signal to the image display device via the transmission channel, thereby making the image display device display an image represented by the image signal, includes a transfer rate derivation section that derives a transfer rate of the image signal when transferring the image signal to the image display device via the transmission channel, and a compression method determination section that determines a compression method of the image signal when supplying the image display device with the image signal by transferring the image signal to the image display device via the transmission channel based on the transfer rate derived in the transfer rate derivation section.

### BACKGROUND

1. Technical Field

The present invention relates to a technology for supplying an image signal to an image display device by transferring the image signal from an image supply device via a predetermined transmission channel.

2. Related Art

In the case in which an image generated by a computer is displayed by projecting with a projector, for example, it is arranged that the computer and the projector are connected with a predetermined transmission channel so that the image signal from the computer is supplied to the projector by transferring the image signal via the transmission channel. However, some kinds of transmission channels offer a relatively low transfer rate of the signal (e.g., USB 1.1 etc.), thus taking long transfer time period of the image signal.

Therefore, a technology has been proposed in which when the image signal is transferred to the projector from the computer, the image signal is previously compressed by the computer, and then the compressed image signal is transferred to the projector, thereby shortening the transfer time period of the image signal (e.g., JP-A-2006-58670).

however, there are some cases in which a long period of time is required for projector to decompress the image signal transferred thereto after compressed because of low processing power of the projector when, for example, an old model year projector is used. Further, similarly, there are some cases in which a long period of time is required to compress the image signal because of low processing power of the computer. Accordingly, there are some cases in which the total processing time period including a period of time (hereinafter simply referred to as compression time period) required for compressing the image signal and a period of time (hereinafter simply referred to as decompression time period) required for decompressing the compressed image signal added to the transfer time period of the image signal even if the transfer time period is shortened. Therefore, in the case in which continuing images are intended to be displayed in the projector by continuously transferring the image signal, a problem arises that an interval is created between the adjacent images, and consequently, the real-time display becomes quite difficult.

### SUMMARY

Therefore, an advantage of the invention is to provide a technology for transferring an image signal to an image display device from an image supply device via a predetermined transmission channel while shortening the period of time for displaying an image represented by the image signal on the image display device, thereby solving the problem of the related art described above.

According to an aspect of the invention, there is provided an image supply device to be connected to an image display device via a predetermined transmission channel, for supplying the image display device with an image signal by transferring the image signal to the image display device via the transmission channel, thereby making the image display device display an image represented by the image signal, including a transfer rate derivation section that derives a transfer rate of the image signal when transferring the image signal to the image display device via the transmission channel, and a compression method determination section that determines a compression method of the image signal when supplying the image display device with the image signal by transferring the image signal to the image display device via the transmission channel based on the transfer rate derived in the transfer rate derivation section.

In the specification, a transfer rate denotes a speed (the amount of data transferred per unit time) of transferring the image data from the image supply device to the image display device via a predetermined transmission channel, and obtained by dividing the data size of the image signal to be transferred by the transfer time period. Further, a transmission channel denotes a medium used for communicating information, and includes, for example, a wired electric communication channel such as a USB cable or an IEEE 1394 cable and a wireless electric communication channel. Further, in the present specification, the compression method includes various compression methods such as JPEG or GIF, and also uncompressing methods (e.g., RAW). Still further, the compression methods of the same kind with different compression ratios can be regarded as different compression methods such as JPEG.

As described above, the image supply device according to a first aspect of the invention determines a compression method when transferring a desired image signal to the image display device in accordance with the transfer rate of the transmission channel. Here, when the image signal is transferred via the transmission channel after compressed, the data size of the compressed image signal is different among the compression methods applied thereto. Meanwhile, a time period required for compressing the image signal with the image supply device and for decompressing the image signal with the image display device (a compression time period+a decompression time period) is also different among the compression method applied thereto. Therefore, in the case in which the transmission channel has a rather high transfer rate, for example, the total processing time period (a compression time period+a transfer time period+a decompression time period) becomes shorter by adopting a compression method requiring shorter time period for compressing and decompressing the image signal as much as the time period shortened by the compression and decompression processes. On the contrary, in the case in which the transfer rate of the transmission channel is rather slow, the total processing time period (a compression time period+a transfer time period+a decompression time period) becomes shorter by adopting a compression method with smaller compressed data size because the data transfer time period can be shortened.

Therefore, according to the image supply device of the first aspect of the invention, as described above, by arranging that the most preferable compression method is determined as desired in accordance with the transfer rate of the transmission channel, the processing time period when transferring the image signal from the image supply device to the image display device via the transmission channel to make the image display device display the image can be shortened.

Further, according to another aspect of the invention, there is provided an image supply device to be connected to an image display device via a predetermined transmission channel, for supplying the image display device with an image signal by transferring the image signal to the image display device via the transmission channel, thereby making the image display device display an image represented by the image signal, including a transfer rate derivation section that derives a transfer rate of the image signal when transferring the image signal to the image display device via the transmission channel, a table obtaining section that obtains a table on which, regarding a specific image signal, at least a size of the specific image signal after compressed and a decompression time period when decompressing the compressed specific image signal in the image display device are described for every compression method, a processing time period calculation section that calculates a time period when at least the compressed specific image signal is transferred to the image display device via the transmission channel, and decompressed in the image display device referring to the derived transfer: rate and the obtained table as a processing time period for every compression method, and a compression method determination section that determines the compression method minimizing the calculated processing time period as the compression method of the image signal when transferring the image signal to the image display device via the transmission channel.

In the present specification, a decompression time period denotes the time period from when the image display device receives the image signal to when it performs a predetermined process. For example, in the case in which the image signal is compressed with the JPEG method, it can be a time period from when the image display device receives the compressed image signal to when it decompresses the compressed signal and finishes storing it in the memory or the like, or in the case of uncompressed image signal, it can be the time period from when the image display device receives the image signal to when it finishes storing it in the memory or the like.

As described above, according to the image supply device of the second aspect of the invention., the time period when at least compressed specific image signal is transferred to the image display device via the transmission channel and then decompressed in the image display device is calculated as the processing time period of the specific image, and the compression method minimizing the calculated processing time period is determined as the compression method when transferring a desired image signal.

Therefore, according to the image supply device of the second aspect of the invention, since the compression method is determined considering not only the transfer rate of the transmission channel but also the decompression time period in the image display device, the compression method can be suitably determined in accordance with the image display device, thus the processing time period described above can be shortened.

Further, the image supply device according to another aspect of the invention further includes a table storage section that stores the table, and the table obtaining section preferably obtains the table from the table storage section.

According to the above configuration, the processing time period is calculated by obtaining the decompression time period from the table provided to the image supply device. Therefore, if, for example, the table regarding various image display devices which can be connected to the image supply device is provided, the compression method can be determined in accordance with the decompression processing power of the connected image display device.

Further, in the image supply device according to another aspect of the invention the table obtaining section preferably obtains the table from the image display device.

As described above, by obtaining the table, on which the decompression time period of the compressed specific image signal in the image display device and so on are described, from the image display device, if the image supply device does not provided with the table regarding the various image display devices, the image supply device can obtain the table provided to the image display device connected to the image supply device, and determine the suitable compression method in accordance with the image display device connected thereto.

Further, in the image supply device according to another aspect of the invention the processing time period calculation section preferably calculates a transfer time period when transferring the compressed specific image signal to the image display device via the transmission channel based on the transfer rate and the size described on the table, and calculates the processing time period for every compression method by adding the decompression time period described on the table and the calculated transfer time period.

As described above, by calculating the transfer time period of the compressed specific image signal and adding the decompression time period of the compressed specific image in the image display device to the transfer time period, the processing time period can easily be calculated.

Further, in the image supply device according to another aspect of the invention there are further described in the table stored in the table storage section, for every compression method, regarding the specific image signal, besides the size and the decompression time period, a compression time period when compressing the specific image signal n the image supply device, and the processing time period calculation section preferably calculates a transfer time period when transferring the compressed specific image signal to the image display device via the transmission channel based on the transfer rate and the size described on the table, and calculates the processing time period for every compression method by adding the decompression time period and the compression time period described on the table and the calculated transfer time period.

As described above, the compression method is determined considering further the compression time period in the image supply device in addition to the transfer rate of the transmission channel and the decompression time period in the image display device, the most preferable compression method can be determined in accordance with the combination of the image supply devices, transmission channels, and the image display devices. Therefore, the processing time period can be shortened in accordance with various combinations of the image supply devices, transmission channels, and the image display devices.

Further, the image supply device according to another aspect of the invention further including a test image supply section for supplying the image display device with a test image signal representing a predetermined test image by transferring the test image signal to the image display device via the transmission channel, and the transfer rate derivation section derives the transfer rate based on a transfer time period of the test image signal supplied to the image display device by the test image supply section via the transmission channel.

For example, the transfer rates may be different even with the same transmission channels between the case in which one image display device is connected to one image supply device and the case in which three image display devices are connected to one image supply device. Therefore, as described above, by actually measuring the transfer time period when transferring the test image signal and determining the compression method based on the transfer rate calculated from the measured transfer time period, a suitable compression method in accordance with the actual busy condition can be determined.

Further, n the image supply device according to another aspect of the invention the test image supply section preferably supplies the image display device with the test image signal by transferring the test image signal to the image display device via the transmission channel in response to establishment of communication with the image display device.

According to the above configuration, when the communication between the image supply device and the image display device is established, the compression method when transferring the desired image signal is automatically determined, and accordingly, the trouble of determining the compression method prior to the user transfers a desired image signal can be eliminated.

Further, the image supply device according to another aspect of the invention further including a transmission channel discrimination section that discriminates a type of the transmission channel, and a transfer rate storage section that stores a transfer rate table showing a transfer rate of the transmission channel for every type of the transmission channel, and the transfer rate derivation section refers to the transfer rate table based on the type of the transmission channel discriminated in the transmission channel discrimination section to derive the transfer rate.

As described above, by discriminating the type of the transmission channel to derive the transfer rate corresponding to the type from the transfer rate table, the transfer rate of the transmission channel can easily be derived.

Further, in the image supply device according to another aspect of the invention the transmission channel discrimination section preferably discriminates the type of the transmission channel in response to establishment of communication with the image display device.

According to the above configuration, when the communication between the image supply device and the image display device is established, the compression method when transferring the desired image signal is automatically determined, and accordingly, the trouble of determining the compression method prior to the user transfers a desired image signal can be eliminated.

According to another aspect of the invention, there is provided an image display device that can be connected to an image supply device via a predetermined transmission channel, including a table storage section that stores a table on which, regarding a specific image signal, at least a size of the specific image signal after compressed and a decompression time period when decompressing the compressed specific image signal in the image display device are described for every compression method, a table transfer section that transfers the table to the image supply device via the transmission channel.

As described above, the image display device according to an aspect of the invention is provided with a table on which the size of the compressed specific image signal and the decompression time period when decompressing the compressed specific image signal are at least described for every compression method, and transfers the information to the image supply device connected via a predetermined transmission channel.

Therefore, according to the image display device of an aspect of the invention; even if the image supplying device is not previously provided with the decompression time period table, the image supply device can obtain the table provided to the image display device connected thereto via the transfer channel by connecting to the image display device, and calculate the processing time period based on the obtained table, thus determining the compression method.

It should be noted that the invention can be put into practice in various forms, such as an image supply device, an image display device, an image transfer system, a compression method determination method, an image supply method, a computer program for realizing the aforementioned methods or devices, a recording medium recording the computer programs, and so on.

### BRIEF DESCRIPTION OF THE DRAWINGS

The invention will now be described with reference to the accompanying drawings, wherein like numbers refer to like elements.

FIG. 1 is a block diagram showing a schematic configuration of an image transfer system as a first embodiment of the invention.

FIG. 2 is a flowchart showing a procedure of a computer 100 for determining a compression method of image data in the image transfer system shown in FIG. 1.

FIG. 3 is a block diagram showing a schematic configuration of an image transfer system as a second embodiment of the invention.

FIG. 4 is a flowchart showing a procedure of a computer 100′ for determining a compression method of image data i the image transfer system shown in FIG. 3.

FIG. 5 is a chart showing a decompression time period table 133 stored in the computer 100′ of the image transfer system shown in FIG. 3.

FIG. 6 is a block diagram showing a schematic configuration of an image transfer system as a third embodiment of the invention.

FIG. 7 is a flowchart showing a procedure of a computer 100″ for determining a compression method of image data in the image transfer system shown In FIG. 6.

FIG. 8 is a flowchart showing a procedure for updating the compression method of the image data in an image transfer system as a modified example.

### DESCRIPTION OF EXEMPLARY EMBODIMENTS

The best mode for putting the invention into practice will now be explained based on embodiments in the following order.

A. First Embodiment

B. Second Embodiment

C. Third Embodiment

D. Modified Example

### A. First Embodiment

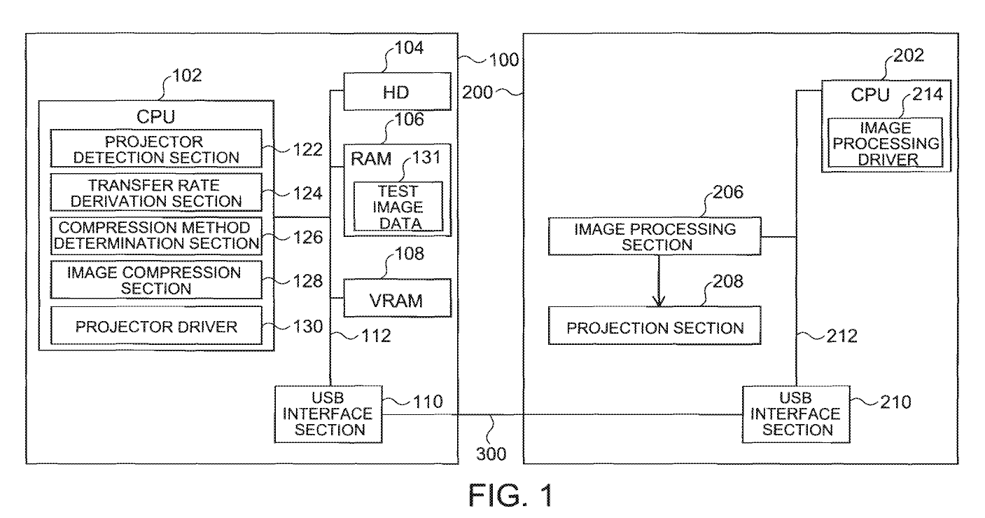

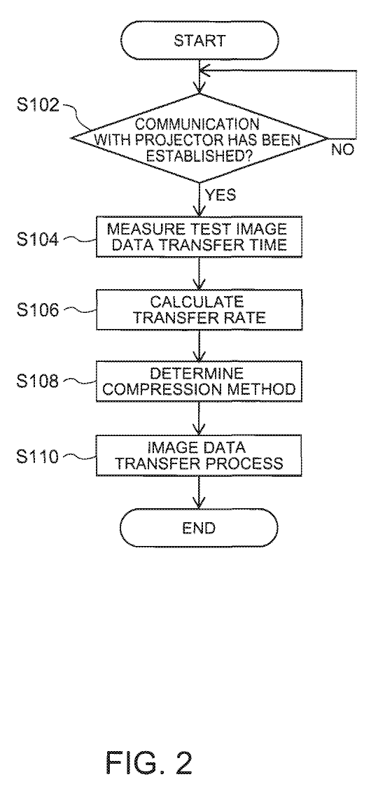

The first embodiment will be explained with reference to FIGS. 1 and 2. FIG. 1 is a block diagram snowing a schematic configuration of an image transfer system equipped with an image supply device as the first embodiment of the invention. As shown in FIG. 1, the image transfer system according to the present embodiment is provided with a computer 100 as an image supply device, a projector 200 as an image display device, and a USE cable 300 for connecting the computer 100 and the projector 200 with each other. The computer 100 has a function of supplying the projector 200 with the image via the USB cable 300 to make the projector 200 project the image to display the image on a screen (not shown).

The computer 100 is, for example, a personal computer, and provided with a CPU 102 for performing various processes and control in accordance with a computer program, an HD 104 for storing the computer program and data, a RAM 106 as a multipurpose memory (also referred to as a system memory), a VRAM 108 as a frame memory, a USB Interface section 110, and a bus 112 for connecting the preceding elements with each other.

It should be noted that although not shown n FIG. 1, as a peripheral device, the computer 100 is also equipped with an input device such as a keyboard or a pointing device, and a display device such as a CRT or a liquid crystal display besides the above.

The HD 104 in FIG. 1 stores various kinds of computer programs and test image data 131, which are loaded to the RAM 106 from the HD 104 upon starting up the computer 100. Then, by performing specified computer programs out of the stored ones, the CPU 102 functions as a projector detection section 122, a transfer rate derivation section 124, a compression method determination section 126, an image compression section 128, and a projector driver 130, respectively. It should be noted that the various kinds of computer programs as described above, are provided in a form of being recorded in a computer readable recording medium such as a flexible disk or a CD-ROM.

Further, the projector driver 130 and the test image data 131 correspond to a test image supply section and a test image signal of the claimed invention, respectively.

On the other hand, the projector 200 is equipped with a CPU 202, an image processing section 206, a projection section 208 including a light source lamp, a liquid crystal panel and a projection optical system, a USB interface section 210, and a bus 212 connecting these elements with each other. Further, a memory (not shown) stores various kinds of computer programs, and the CPU 202 functions as an image processing driver 214 by performing a specific program out of these computer programs.

It should be noted that although not shown in FIG. 1, the projector 200 is additionally equipped with an input section including various kinds of operation buttons, a ROM, a RAM, and so on.

FIG. 2 is a flowchart showing a procedure for determining a compression method of image data when the computer 130 transfers the image data to the projector 200 in the image transfer system shown in FIG. 1.

Then, the action of the present embodiment will be explained with reference to FIG. 2 taking the case in which the user connects the projector 200 to the computer 100 to display desired image data on a screen (not shown) by transferring it from the computer 100 to the projector 200 as an example.

Firstly, when the user starts up the computer 100 and the projector 200 connected to the computer 100, communication between the computer 100 and the projector 200 is established, and the projector detection section 122 of the computer 100 detects the establishment of the communication via the USB interface section 110 (step S102). When the establishment of the communication is detected in the projector detection section 122, the transfer rate derivation section 124 instructs the projector driver 130 to transfer the test image data 131 stored in the RAM 106 to the projector 200, and the projector driver 130 then transfers the test data 131 to the projector 200 via the USB interface section 110. The image processing driver 214 of the projector 200 sends out a signal (hereinafter referred to as a test image data reception signal) representing reception of the test image data 131 to the computer 100 via the USB interface section 210 upon reception of the test image data 131 via the USB interface section 210. The transfer rate derivation section 124 of the computer 100 measures a time period from the projector driver 130 transferring the test image data 131 to the projector 200 receiving the test image data 131 (step S104). Specifically, the transfer rate derivation section 124 acquires the time point when the projector driver 130 sends out the test image data 131 and the time point when the test image data reception signal is received from the projector 200 to measure the transfer time period from the difference between them (step S104). Then, the transfer rate derivation section 124 calculates the transfer rate (hereinafter simply referred to as a USB cable transfer rate) when transferring image data via the USB cable 300 from the transfer time period thus measured and a data size of the test image data 131 (step S106).

The compression method determination section 126 determines the compression method when transferring desired image data to the projector 200 based on the transfer rate thus calculated by the transfer rate derivation section 124 (step S108). Specifically, the program is previously described so as to select the JPEG method when the transfer rate is lower than 400 Mbps or the RAW method when it is no lower than 400 Mbps, for example, and the compression method is thus determined in accordance with the calculated transfer rate (step S108). Then, if the determined compression method is the RAW method (uncompressed), the projector driver 130 is instructed to send out the image data in the VRAM 108 to the projector 200 via the USB interface section 110. On the other hand, if it is determined to be the JPEG method, the image compression section 128 is instructed to compress the image data in the VRAM 108 with the JPEG method.

Therefore, if it is determined to be the RAW method in the compression method determination section 126, the projection driver 130 transfers the image data in the VRAM 108 to the projector 200 via the USB interface section 110 without compression (step S110). On the other hand, if it is determined to be the JPEG method, in response to the image compress-on section 128 compressing the image data in the VRAM 108 in the JPEG method, the projector driver 130 then transfers the image data (hereinafter referred to as compressed image data) thus compressed to the projector 200 via the USE interface section 110 (step S110).

The image processing driver 214 of the projector 200 receives the compressed image data or the uncompressed image data via the USB interface section 210. In response to receiving the compressed image data, the image processing driver 2141 controls the image processing section 206 to decompress the compressed image data in the display memory (not shown) inside the image processing section 206 by itself, and then perform predetermined image processing on the image data thus decompressed. On the other hand, if the image processing driver 214 receives the uncompressed image data, it makes the image processing section 206 perform predetermined image processing on the image data as it is.

The projection section 208 displays an image by projecting it on the screen in accordance with the image data from the image processing section.

As described above, in the present embodiment, it is arranged that the transfer time period is measured by transferring the test image data 131 to the projector 200, and in accordance with the transfer time period, the compression method in transferring image data is determined to be the JPEG method when the transfer rate lower than 400 Mbps and the RAW method (uncompressed) when the transfer rate is no lower than 400 Mbps, respectively.

Therefore, for example, the case in which the USB cable 300 is a cable compliant with the USB 1.1 standard and the transfer rate is 12 Mbps is considered. If the transfer rate is 12 Mbps, as described above, the JPEG method is determined as the compression method. If certain image data is now compressed with the JPEG method thus determined, and transferred via the cable, the transfer time period becomes about 2000 ms shorter than the case in which the same image data is transferred with the RAW method (uncompressed). Further, a decompression time period of about 600 ms is required for the projector to decompress the image data compressed with the JPEG method. Therefore, comparing the processing time period including the transfer time period and the decompression time period added thereto between the case of transferring with the RAW method (uncompressed), it is understood that the processing time period becomes shorter in the case of transferring after compressed with the JPEG method.

Then, the case in which the USB cable 300 is a cable compliant with the USB 2.0 standard and the transfer rate is 480 Mbps is considered. If the transfer rate is 480 Mbps, as described above, the RAW method (uncompressed) is determined as the compression method. Transfer of certain image data with the RAW method (uncompressed) takes 50 ms more than the case of transferring the same image data compressed with the JPEG method. However, although it takes about 60 ms to decompress the image data compressed with the JPEG method in the projector, the decompression time period in the case of transferring with the RAW method (uncompressed) is very short. Therefore, comparing the processing time period including the transfer time period and the decompression time period added thereto between the case of transferring after decompressed with the JPEG method, it is understood that the processing time period becomes shorter in the case of transferring with the RAW method (uncompressed).

Therefore, if it is previously arranged that, for example, in consideration of the transfer time period, the decompression time period, the compression time period, and so on, the compression method for shortening the processing time period is set in accordance with the transfer rate as the compression method to be determined in accordance with the transfer rate of the USB cable 300, it is possible to shorten the processing time period by using the determined compression method.

Further, in the present embodiment, in deriving the transfer rate of the USB cable 300, the test image data 131 is transferred, and the transfer rate is calculated from the transfer time period thereof. Therefore, when a desired image data is transferred, the compression method can be determined based on the transfer rate in that busy condition. For example, there are some cases having different transfer rates in accordance with the busy conditions thereof even if the same USB cable 300 is used, and even in those cases, suitable compression methods in accordance with the busy conditions thereof can be determined.

### B. Second Embodiment

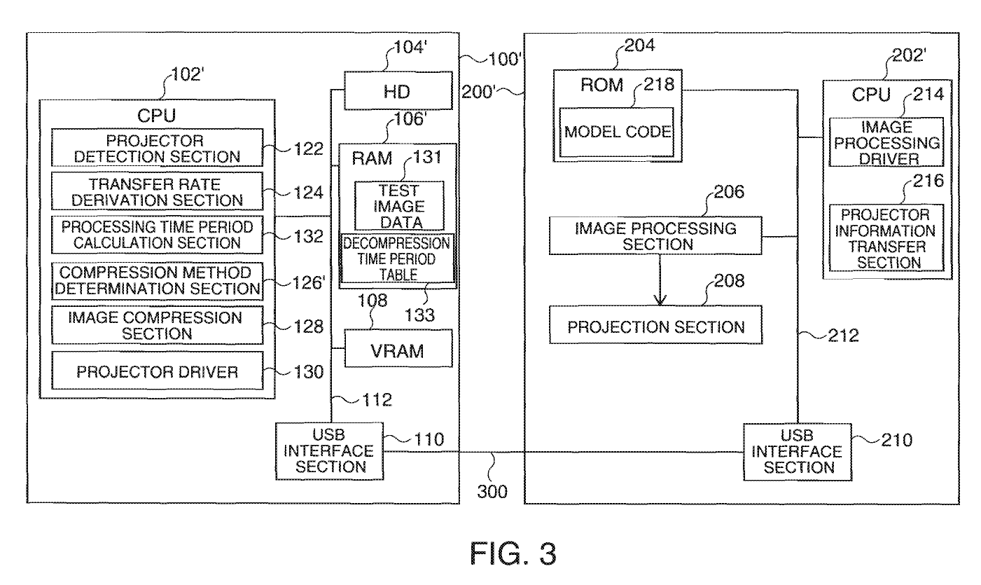

The second embodiment will now be explained with reference to FIGS. 3 through 5. FIG. 3 is a block diagram showing a schematic configuration of an image transfer system equipped with an image supply device as the second embodiment of the invention.

As shown in FIG. 3, similarly to the first embodiment, the image transfer system according to the present embodiment is provided with a computer 100′ as an image supply device, a projector 200′ as an image display device, and the USB cable 300 for connecting the computer 100′ and the projector 200′ with each other.

The computer 100′ has the same hardware configuration as that of the first embodiment shown in FIG. 1, but differs in a part of the program executed by the CPU 102′ therefrom, wherein the CPU 102′ also functions as a processing time period calculation section 132. Further, the RAM 106′ stores a decompression time period table 133 in addition to the test image data 131.

It should be noted that the decompression time period table 133 and the RAM 106′ correspond to a table and a table storage section of the claimed invention, respectively.

On the other hand, the projector 200′ also has the same hardware configuration as the first embodiment shown in FIG. 1, but differs in a part of the program executed by the CPU 202′ therefrom. Further, a ROM 204 (the ROM is not shown in FIG. 1) stores a model code 218. The model code 218 is an identification code representing the model of the projector 200′.

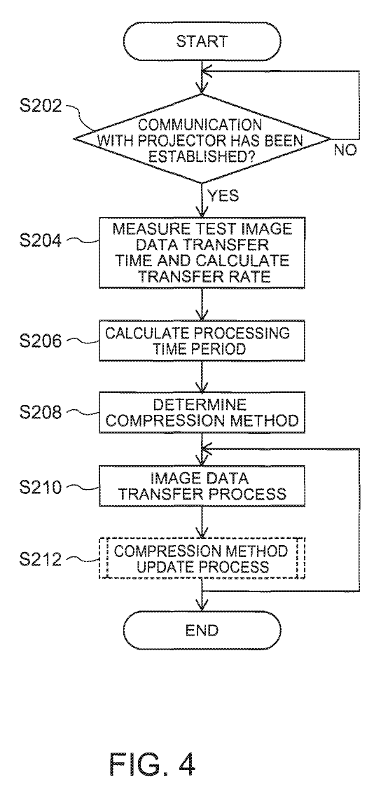

Then, the action of the present embodiment will be explained with reference to FIGS. 3 through 5 taking the case in which the user connects the projector 200′ to the computer 100′ to display desired image data on a screen (not shown) by transferring it from the computer 100′ to the projector 200′ as an example. FIG. 4 is a flowchart showing a procedure for determining a compression method of image data when the computer 100′ transfers the image data to the projector 200′ in the image transfer system shown in FIG. 3. It should be noted that in FIG. 4 a compression method updating process (step S212) illustrated with broken lines shows an action in a modified example described later, and the compression method updating process is not performed In the present embodiment.

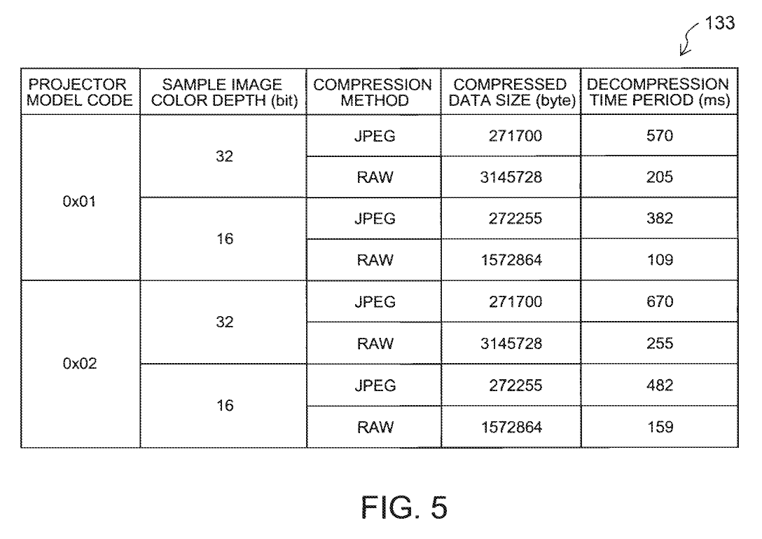

Further, FIG. 5 shows the decompression time period table 133 stored in the RAM 106′ of the computer 100′. The decompression time period table 133 will now be explained here. Various models of projectors can be connected to the computer 100′. Further, when the computer 100′ transfers compressed image data to those projectors to make the projectors decompress it, the decompression time periods for decompressing the compressed image data are different for every model because the processing power is different for every model. Further, since the way of decompression is also different for every decompression method, the decompression time period is different for every decompression method even in the same model. Further, since compression ratios are different in the different color depths of the image data even in the same compression method, the decompression time periods are also different.

Therefore, in the present embodiment, a plurality of target projectors is previously prepared, and sample image data with two different color depths is also prepared previously. Then, the sample image data is compressed with respective compression methods by changing the compression method to create the compressed image data for every compression method, and the data sizes thereof are calculated. Further, the compressed image data for every compression method is decompressed by each model of the projectors, and the decompression time periods are measured. Thus, the data size (hereinafter simply referred to as a compressed data size) and the decompression time period of the compressed sample image is previously obtained in accordance with the compression method for every model of the projectors, and the decompression time period table 133 shown in FIG. 5 is created using the obtained compression data sizes and the decompression time periods. It should be noted that a still image is used for the sample image.

Firstly, when the user starts up the computer 100′ and the projector 200′ connected to the computer 100′, and communication between the computer 100′ and the projector 200′ established, the projector detection section 122 of the computer 100′ detects the establishment of the communication via the USB Interface section 110 (step S202). Further, when establishing the communication, the projector 200′ makes the color depth fit the color depth of the computer 100′ by negotiating with the computer 100′. It is assumed here that the projector 200′ in the present embodiment can adopt two kinds of color depths of 32 bit and 16 bit, and has adopted 32 bit of color depth in accordance with the color depth of the computer 100′. When the establishment of the communication is detected in the projector detection section 122, similarly to the first embodiment, the transfer rate derivation section 124 measures the transfer time period of the test image data 131, and calculates the transfer rate of the USB cable 300 based on the transfer time period thus measured (step S204).

Then, when the processing time period calculation section 132 sends out an acquisition request of the projector information to the projector 200′ via the USB interface section 110, a projector information transfer section 216 of the projector 200′ retrieves the model code 218 in the ROM 204 to transfer it to the computer 100′ via the USB interface section 210.

Then, the processing time period calculation section 132 receives the model code 218 of the projector 2003 via the USB interface section 110, and refers to the decompression time period table 133 in the RAM 106′ based on the received model code 218 and the color depth of the computer 100′ to obtain the decompressed data size and the decompression time period for every compression method. As shown in FIG. 5, if the model code 218 of the projector 200′ is, for example 0x01, in consideration that the color depth is 32 bit as described above, it is assumed that the compressed data sizes of 271700 bytes (JPEG) and 3145728 bytes (RAM) are obtained and the corresponding decompression time periods of 570 ms (JPEG) and 205 ms (RAW) are obtained, respectively. It should be noted here that the decompression time period in the present embodiment denotes a time period from when the image processing driver 214 of the projector 200′ receives the compressed sample image data to when the image processing section 206 decompresses the compressed sample image data and finishes writing the sample image data in a memory (off-screen memory) not shown, or a time period from when the image processing driver 214 receives the uncompressed sample image data to when the image processing section 206 finishes writing the sample image data in the memory (off-screen memory) not shown.

The processing time period calculation section 132 calculates the transfer time period in the case in which the sample image data compressed with the JPEG method is transferred and the transfer time period in the case in which the sample image data of the RAW method (uncompressed) is transferred, respectively, based on the transfer rates calculated by the transfer rate derivation section 124 and the compressed data sizes obtained from the decompression time period table 133 Then, the processing time periods are calculated by adding the decompression time periods obtained from the decompression time period table 133 to the transfer time periods calculated for the JPEG method and the RAW method (uncompressed)/respectively (step S206).

Then, the compression method determination section 120′ compares the processing time periods for respective compression methods calculated by the processing time period calculation section 132, and determines the compression method with the shorter processing time period as the compression method used when transferring desired image data to the projector 200′ (step S208). For example, it is assumed that the processing time period when transferring the image with the JPEG method is 751 ms while the processing time period when transferring the image with the RAW method is 2302 ms if the transfer rate calculated in the transfer rate derivation section 124 is 12 Mbps. In this case, since the JPEG method has the shorter processing time period in comparison between the both sides, the compression method is determined to be the JPEG method. On the contrary, for example, it is assumed that the processing time period when transferring the image with the JPEG method is 575 ms while the processing time period when transferring the image with the RAW method is 257 ms if the transfer rate calculated in the transfer rate derivation section 124 is 480 MBps. In this case, since the RAW method has the shorter processing time period in comparison between the both sides, the compression method is determined to be the RAW method.

Then, if the determined compression method is the RAW method (uncompressed), the compression method determination section 126′ instructs the projector driver 130 to send out the image data in the VRAM 108 to the projector 200′ via the USB interface section 110. On the other hand, if it is determined to be the JPEG method, the image compression section 128 is instructed to compress the image data in the VRAM 108 with the JPEG method.

Therefore, if it is determined to be the RAW method in the compression method determination section 126′, the projection driver 130 transfers the image data in the VRAM 108 to the projector 200′ via the USB interface section 110 without compression (step S210). On the other hand, if it is determined to be the JPEG method, in response to the image compression section 128 compressing the image data in the VRAM 103 in the JPEG method, the projector driver 130 then transfers the compressed image data to the projector 200′ via the USB interface section 110 (step S210).

Then, similarly to the first embodiment, the image processing driver 214 of the projector 200′ receives the compressed image data or the uncompressed image data via the USE interface section 210. Therefore, similarly to the first embodiment, the image processing section 206 performs the image processing on the image data, and the projection section 208 displays the image by projecting it on the screen in accordance with the image data from the image data processing section 206.

As described above, in the present embodiment, the processing time period is calculated by adding the decompression time period of the compressed image data in the projector 200, to the transfer time period, and the compression method is determined based on the processing time period. Since the decompression processing power of the projector is different among model, years or types of the projectors, the decompression time period is different among the models when the projector decompresses the image data compressed with the same compression method. Therefore, in comparison between the processing time periods of two image transfer systems having the same models of computers, the same models of transmission channels, and different models of projectors, the transfer time periods are the same, but the processing time periods are different because the decompression time periods in the projectors are different. In such a case, according to the present embodiment, since the processing time period obtained by adding the decompression time period to the transfer time period is calculated in accordance with the model of the projector connected to the computer, and the compression method is determined so that the processing time period becomes minimum, the processing time period can always be shortened even if the model of the projector connected to the computer is changed.

### C. Third Embodiment

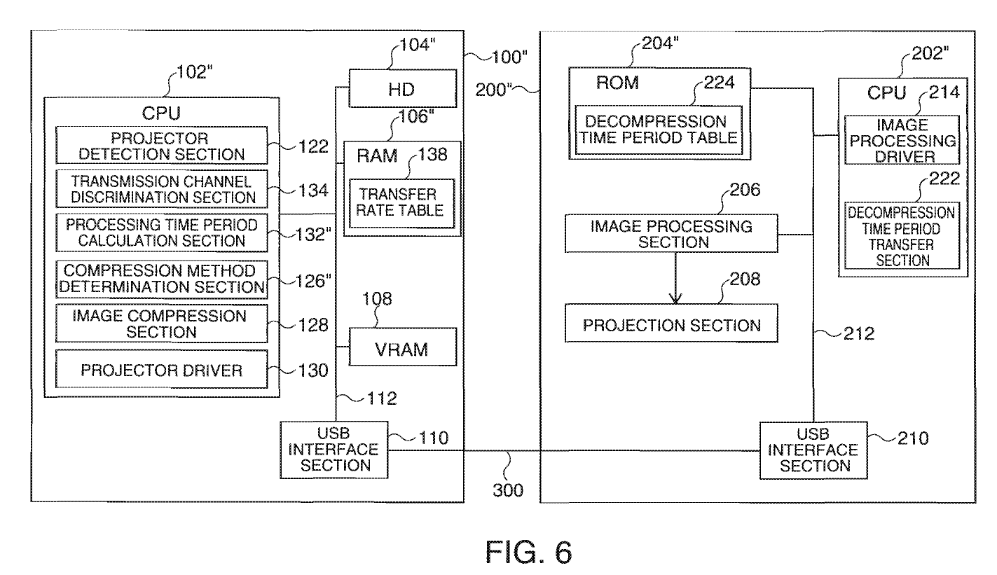

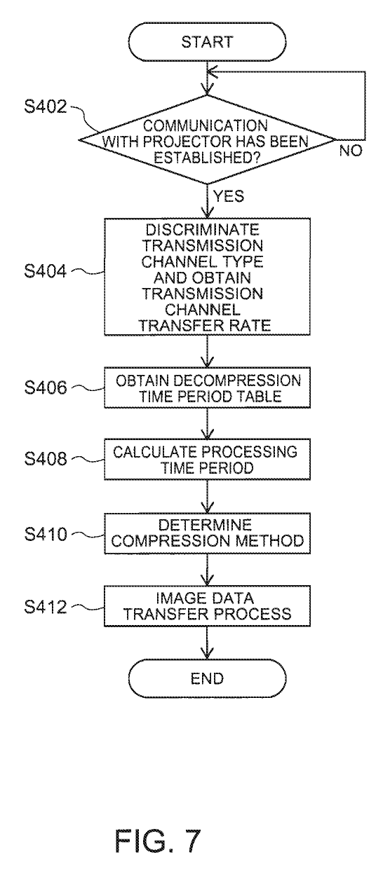

The third embodiment will now be explained with reference to FIGS. 6 and 7. FIG. 6 is a block diagram showing a schematic configuration of an image transfer system as the third embodiment of the invention.

As shown in FIG. 6, similarly to the second embodiment, the image transfer system according to the present embodiment is provided with a computer 100″ as an image supply device, a projector 200″ as an image display device, and the USB cable 300 for connecting the computer 100″ and the projector 200″ with each other. In the present embodiment, the USB cable 300 is assumed to be a cable compliant with the USB 2.0 standard.

The computer 100″ has the same hardware configuration as that of the second embodiment shown in FIG. 3, but differs in a part of the program executed by the CPU 102″ therefrom, wherein the CPU 102″ also functions as a transmission channel discrimination section 134. Further, the RAM 106″ stores a transfer rate table 138. It should be noted here that the transfer rate table 138 is a table for showing the transfer rate corresponding to the type of the transmission channel for every type of the transmission channel, and shows 12 Mbps for the USB 1.1 and 480 Mbps for the USB 2.0, for example.

Further, the transmission channel discrimination sect on 134 corresponds to a transmission channel discrimination section and a transfer rate derivation section in the claimed invention.

On the other hand, the projector 200″ also has the same hardware configuration as the second embodiment shown FIG. 3, but differs in a part of the program executed by the CPU 202″ therefrom. Further, the ROM 204″ stores a decompression time period table 224. The decompression time period table is a table for showing the decompression processing power of the projector 200″, and the compressed data size of the sample image and the decompression time period of the compressed sample image in the projector 200″ are described thereon for every compression method. It should be noted that the decompression time period table 224 and the ROM 204″ correspond to a table and a table storage section of the claimed invention, respectively.

Then, the action of the present embodiment will be explained with reference to FIG. 7 taking the case in which the user connects the projector 200″ to the computer 100″ to display desired image data on a screen (not shown) by transferring it from the computer 100″ to the projector 200″ as an example. FIG. 7 is a flowchart showing a procedure for determining a compression method of image data when the computer 100″ transfers the image data to the projector 200″ in the image transfer system shown in FIG. 6.

Firstly, when the user starts up the computer 100″ and the projector 200″ connected to the computer 100″, and communication between the computer 100″ and the projector 200″ is established, the projector detection section 122 of the computer 100″ detects the establishment of the communication via the USB interface section 110 (step S402). When the projector detection section 122 detects the establishment of the communication, the transmission channel discrimination section 134 inquires of the USB interface section 110 about whether the USB cable 300 is a cable compliant with the USB 1.1 standard or the USB 2.0 standard. As described above, since the USB cable 300 is compliant with the USB 2.0 standard, the USB interface section 110 returns that the USE cable 300 is a cable compliant with the USB 2.0 standard. Thus, the transmission channel discrimination section 134 obtains the transfer rate corresponding to the USB 2.0 with reference to the transfer rate table 138 in the RAM 106″ (step S404).

Subsequently, when the processing time period calculation section 132″ demands the projector 200″ via the USB interface section 110 to obtain the decompression time period, a decompression time period transfer section 222 of the projector 200″ transfers the decompression time period table 224 to the computer 100″ via the USB interface section 210 in response to the demand. Thus, the decompression time period table 224 including the compressed data size and the decompression time period of the projector 200″ for every compression method is obtained (step S406). Then, the processing time period calculation section 132″ calculates the transfer time period corresponding to every compression method from the transfer rate of the USB cable 300 obtained in the transmission channel discrimination section 134 and the compressed data size included in the decompression time period table 224 transferred from the projector 200″. Further, the processing time period is calculated for every compression method by adding the decompression time period described in the decompression time period table 224 to the calculated transfer time period (step S408). The compression method determination section 126″ compares the processing time periods for respective compression methods calculated in the processing time period calculation section 132″, and determines the compression method with which the processing time period becomes minimum as the compression method used when transferring the image data in the VRAM 108 via the USB cable 300 (step S410). Then, similarly to the first embodiment, the projector driver 130 transfers the image data in the VRAM 108 to the projector 200″ via the USB interface section 110 in accordance with the determined compression method (step S412).

Similarly to the first embodiment, the image processing driver 214 of the projector 200″ receives the compressed image data or the uncompressed image data via the USB interface section 210. Therefore, similarly to the first embodiment, the Image processing section 206 performs the image processing on the image data, and the projection section 208 displays the image by projecting it on the screen in accordance with the image data from the image data processing section 206.

As described above, in the present embodiment, instead of the actual measurement of the transfer rate of the USB cable 300, the transfer rate is obtained by referring to the transfer rate table 138 previously stored in the RAM 106″ in accordance with the types of the transmission channels. Further, the decompression time period table 224 referred to when calculating the processing time period is obtained from the projector 200″.

Therefore, since the computer 100″ does not have the test image data or the decompress on time period table, the data necessary for determining the compression method can be made compact. Further, similarly to the first or the second embodiment, the processing time period can be shortened.

### D. Modified Example

It should be noted that the invention not limited to the specific examples or the embodiments described above, but can be put into practice in various forms within the scope of the invention.

In the first or the second embodiment described above, when the communication between the computer and the projector is established, the test image data 131 is sent out to measure the transfer time period in transferring the test image data 131 via the USB cable 300, and the transfer rate of the USB cable 300 is calculated from the measured transfer time period to determine the compression method used when transferring desired image data. Specifically, after the compression method has once been determined, the transfer processes of a series of image data is performed repeatedly in accordance with the compression method without changing the compression method. However, even after the compression method has been determined as described above, it is possible to measure the transfer time period using the image data transferred on regular or irregular basis to calculate the transfer rate, and to determine the compression method based on the transfer rate every time the transfer rate is calculated, thereby updating the compression method so as that the compression method is always the most appropriate.

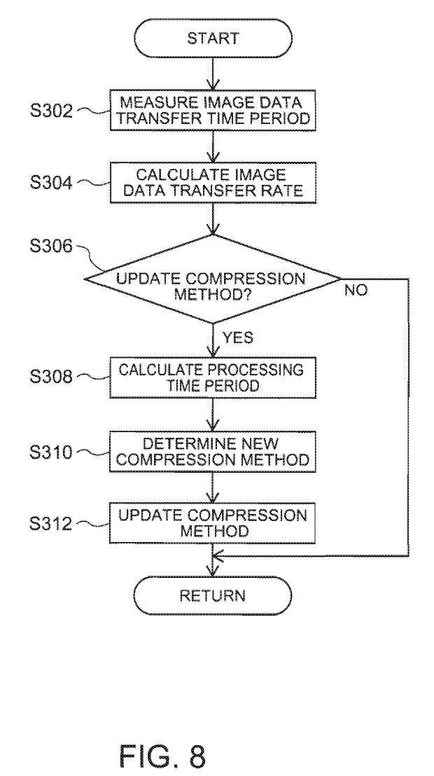

Then, such a modified embodiment will now be explained based on the image transfer system (the second embodiment) shown in FIG. 3. As described above, in the modified example, the compression method updating process (step S212) illustrated with the broken lines is added in the flowchart shown in FIG. 4. Further, FIG. 8 is a flowchart showing the procedure of updating the compression method in the compression method updating process S212.

The CPU 102′ performs the steps S202 through S208 shown in FIG. 4, and performs the transfer process of the image data with the determined compression method (step S210). In the transfer process of the image data, the transfer rate derivation section 124 obtains the data size of the image data in the VRAM 108 after compressed in the image compression section 128. Further, the transfer rate derivation section 124 measures a time period from when the projector driver 130 transfers the compressed image data to when the projector 200′ receives the compressed image data as the transfer time period (step S302 in FIG. 8). Specifically, the image processing driver 214 of the projector 200′ sends out a signal (hereinafter referred to as an image data reception signal) representing reception of the image data to the computer 100, via the USB interface section 210 upon reception of the compressed image data via the USB interface section 210. The transfer rate derivation section 124 receives the image data reception signal via the USB interface section 110, and obtains the time point when the projector driver 130 sends out the compressed image data and the time point when the image data reception signal is received from the projector 200′, thus measuring the transfer time period from the difference between the time points. Then, the transfer rate of the compressed image data is calculated from the obtained data size and the transfer time period measured in the step S302) (step S304). Every time the projector driver 130 transfers the image data, the transfer rate derivation section 124 measures the transfer time period thereof (step S302) to calculate the transfer rate (step S304). Further, it judges whether or not the compression method should be updated or not based on the presently calculated transfer rate and the previously calculated transfer rate (step S306). Specifically, in the case in which the calculated transfer rate has been dramatically changed and the state has continued for a predetermined period of time (e.g., five seconds), the compression method is judged to be updated. Further, if the judgment of updating the compression method has been made, the processing time period calculation section 132 calculates the processing time period (a time period obtained by adding the decompression time period to the transfer time period) using the transfer rate calculated in the step S304 similarly to the step S206 (step S308). The compression method determination section 126′ compares the processing time periods for respective compression methods calculated in the step S308 to determine the compression method with which the processing time period becomes minimum as the new compression method (step S310). Then, the compression method used when transferring the image data in the VRAM 108 to the projector 200′ is updated to the compression method determined In the step S310 (step S312). In this case, if the compression method minimizing the processing time period is different from the previous compression method, the compression method is switched by the update, but if the compression method minimizing the processing time period is the same as the previous compression method, the compression method is not switched by the update. After then, based on the updated compression method, similarly to the second embodiment, the image data in the VRAM 108 is transferred (step S210). On the other hand, if the compression method is not updated (step S306), it is compressed with the compression method as it stands, and the transfer process is continued (step S210).

With the above procedure, it becomes possible to change the compression method in the middle of the transfer process of a series of image data. Therefore, in such a case in which the number of projectors increases in the middle of the transfer process to make the transfer rate of the transmission channel lower, it becomes possible to transfer image data by compressing it with a suitable compression method for the transfer rate.

Further, in the second and the third embodiments described above, the compression method is determined based on the processing time period obtained by adding the decompression time period of the compressed image data in the projector to the transfer time period when transferring the image data via the USB cable 300. However, it is also possible that the computer is further provided with a table showing the compression time period of the sample image data in the computer for every compression method to calculate the processing time period obtained by adding the transfer time period, the decompression time period, and the compression time period, and compares the processing time periods of respective compression methods, thereby determining the compression method minimizing the processing time period. With the above procedure, it becomes possible to determine the compression method considering the whole of three factors of the transfer processing power of the transmission channel, the decompression processing power of the projector, and the compression processing power of the computer.

Further, although in the firsts and the second embodiments described above, the transfer rate of the transmission channel is detected using the test image data 131, it is also possible to detect the transfer rate of the transmission channel using another signal such as a ping signal.

Further, although in the second embodiment described above, in obtaining the compressed data size and the decompression time period for every compression method with reference to the decompression time period table 133, they are obtained based on the color death of the computer 100′, it is also possible to obtain the color depth data according to the color depth adopted by the projector 200′ from the projector 200′.

Further, although in the third embodiments described above, the transfer rate table 138 on which the transfer rates corresponding to types of the transmission channels are described is stored in the computer 100″, it can also be stored in the projector 200″. With the above configuration, similarly to the decompression time period table 224, it becomes possible to transfer it from the projector 200″ to the computer 100″ in accordance with the acquisition demand of the transfer rate from the computer 100″.

Further, the transmission channel discrimination section 134 can also be stored in the projector 200″. With the above configuration, it becomes possible that the projector 200″ determines the type of the transmission channel and send out the transfer rate thereof to the computer 100″.

Therefore, the amount of data stored in the computer 100″ for determining the compression method can be made small.

The entire disclosure of Japanese Patent Application No. 2006-087349, filed Mar. 28, 2006 is expressly incorporated by reference.

What is claimed is:

1. An image supply device to be connected to an image display device via a predetermined transmission channel, for supplying the image display device with an image signal by transferring the image signal to the image display device via the transmission channel, thereby making the image display device display an image represented by the image signal, comprising:
a transfer rate derivation section that derives a transfer rate of the image signal when transferring the image signal to the image display device via the transmission channel; and
a compression method determination section that determines a compression method of the image signal when supplying the image display device with the image signal by transferring the image signal to the image display device via the transmission channel based on the transfer rate derived in the transfer rate derivation section.

2. An image supply device to be connected to an image display device via a predetermined transmission channel, for supplying the image display device with an image signal by transferring the image signal to the image display device via the transmission channel, thereby making the image display device display an image represented by the display signal, comprising:
a transfer rate derivation section that derives a transfer rate of the image signal when transferring the image signal to the image display device via the transmission channel;
a table obtaining section that obtains a table on which, regarding a specific image signal, at least a size of the specific image signal after compressed and a decompression time period when decompressing the compressed specific image signal in the image display device are described for every compression method;
a processing time period calculation section that calculates a time period when at least the compressed specific image signal is transferred to the image display device via the transmission channel, and decompressed in the image display device referring to the derived transfer rate and the obtained table as a processing time period for every compression method; and
a compression method determination section that determines the compression method minimizing the calculated processing time period as the compression method of the image signal when transferring the image signal to the image display device via the transmission channel.

3. The image supply device according to claim 2,
further comprising
a table storage section that stores the table,
wherein
the table obtaining section obtains the table from the table storage section.

4. The image supply device according to claim 2,
wherein
the table obtaining section obtains the table from the image display device.

5. The image supply device according to claim 2,
wherein
the processing time period calculation section calculates a transfer time period when transferring the compressed specific image signal to the image display device via the transmission channel based on the transfer rate and the size described on the table, and calculates the processing time period for every compression method by adding the decompression time period described on the table and the calculated transfer time period.

6. The image supply device according to claim 2,
wherein
in the table, there are further described for every compression method, regarding the specific image signal, besides the size and the decompression time period, a compression time period when compressing the specific image signal in the image supply device, and
the processing time period calculation section calculates a transfer time period when transferring the compressed specific image signal to the image display device via the transmission channel based on the transfer rate and the size described on the tables and calculates the processing time period for every compression method by adding the decompression time period and the compression time period described on the table and the calculated transfer time period.

7. The image supply device according to claim 1,
further comprising
a test image supply section for supplying the image display device with a test image signal representing a predetermined test image by transferring the test image signal to the image display device via the transmission channel,
wherein
the transfer rate derivation section derives the transfer rate based on a transfer time period of the test image signal supplied to the image display device by the test image supply section via the transmission channel.

8. The image supply device according to claim 7,
wherein
the test image supply section supplies the image display device with the test image signal by transferring the test image signal to the image display device via the transmission channel in response to establishment of communication with the image display device.

9. The image supply device according to claim 1
further comprising:
a transmission channel discrimination section that discriminates a type of the transmission channel; and
a transfer rate storage section that stores a transfer rate table showing a transfer rate of the transmission channel for every type of the transmission channel,
wherein
the transfer rate derivation section refers to the transfer rate table based on the type of the transmission channel discriminated in the transmission channel discrimination section to derive the transfer rate.

10. The image supply device according to claim 9,
wherein
the transmission channel discrimination section discriminates the type of the transmission channel in response to establishment of communication with the image display device.

11. An image display device that can be connected to an image supply device via a predetermined transmission channel, comprising:
a table storage section that stores a table on which, regarding a specific image signal, at least a size of the specific image signal after compressed and a decompression time period when decompressing the compressed specific image signal in the image display device are described for every compression method; and
a table transfer section that transfers the table to the image supply device via the transmission channel.
